(19) United States
(12) Patent Application Publication
(10) Pub. No.: US 2023/0031354 A1
(43) Pub. Date: Feb. 2, 2023

(54) ABRIDGED CONTAINER IMAGES

(71) Applicant: Hewlett-Packard Development Company, L.P., Spring, TX (US)

(72) Inventor: Zachary Tahenakos, Fort Collins, CO (US)

(73) Assignee: Hewlett-Packard Development Company, L.P., Spring, TX (US)

(21) Appl. No.: 17/791,231

(22) PCT Filed: Feb. 12, 2020
(86) PCT No.: PCT/US2020/017870

§ 371 Date: Jul. 7, 2022

(51) Int. Cl. G06F 8/61; G06F 8/71

(52) U.S. Cl. CPC G06F 8/63; G06F 8/71

(57) ABSTRACT

An example system may include a processor and a non-transitory machine-readable storage medium storing instructions executable by the processor to issue a request from an intermediary system to a daemon service to export a container image, including a plurality of individually executable prerequisite layers, from a host, wherein the plurality of individually executable prerequisite layers includes a first individually executable prerequisite layer absent from a target system and a second individually executable prerequisite layer installed on the target system; and convert the exported container image to an abridged container image, deliverable to the target system, by copying the first individually executable prerequisite layer to an abridged deliverable container image location without the second individually executable prerequisite layer.

### BACKGROUND

Software applications (e.g., sets of instructions executable by a processor to perform various functions) may be developed and delivered to end users via a variety of mechanisms. For example, a software application may be developed, packaged, and/or delivered as a container. A container may be isolated from other containers and include a bundle of its own instructions, libraries, configuration files, etc. which may be run by a single operating system kernel.

### BRIEF DESCRIPTION OF THE DRAWINGS

FIG. 1 illustrates an example of a system for generating abridged container images consistent with the present disclosure.

FIG. 2 illustrates an example of a computing device for generating abridged container images consistent with the present disclosure.

FIG. 3 illustrates an example of a non-transitory machine-readable memory and processor for generating abridged container images consistent with the present disclosure.

FIG. 4 illustrates an example of a method for generating abridged container images consistent with the present disclosure.

### DETAILED DESCRIPTION

Software applications and their development have shifted to development, delivery, execution, and versioning mechanisms that are capable of keeping the software applications on a same host or cluster in an isolated manner where they don't interfere with one another's operation and/or maintenance. One such mechanism for software application development, delivery, execution, and versioning has been virtual machines (VMs). VMs, however, typically utilize their own operating system (O/S). Consequently, VMs may be relatively bulky (e.g., gigabytes (GBs) in size) and difficult to maintain and upgrade.

Conversely, a software application container may isolate software applications' execution environments from one another, but the applications may share a common underlying O/S kernel of the host or cluster. As such, the software application container, including its instructions, libraries, configuration files, media assets, etc., may be relatively lightweight (e.g., megabytes (MB) in size), may not utilize a guest O/S, may not utilize a hypervisor, and may utilize fewer host resources to execute than a VM.

Software application containers, such as traditional Linux containers, utilize an initialization (init) process that may manage multiple processes allowing the entire application to run as one. Running the entire application as one may provide the functionality of the software application, but granularity in creation, building, updating, delivering, versioning, executing etc. may be sacrificed.

As such, a software application container, such as a Docker container, may be utilized to facilitate the break down of the software application into its component parts to provide this granularity. For example, a software application container that facilitates the breakdown of the software application into its component parts may facilitate the ability to take down a part of an application for update or repair without necessarily taking down the whole software application.

Additionally, the break down of a software application into individual consistent components such as microservices that are separate, self-contained, and individually executable software application components may provide a modular microservice-based architecture to the software application container. That is, the modularity of a microservices-based approach may facilitate the sharing of processes amongst multiple software applications.

Creating and/or utilizing a software application container may include creating and/or utilizing an image. An image may include a read-only template with instructions for creating the software application container. That is, an image may include a portable file containing the specifications for which software components the container will run and how.

A software application image may be built up from a series of layers. Each layer may be made up of the file generated from running each command in a container building file, such as a Docker file, for building the software application container. For example, the container building file may contain commands (FROM, COPY, RUN, MAKE, ADD, etc.), each of which, when executed, creates a layer in an image.

Each layer may include a set of differences from the layer before it. The layer may be built or stacked upon the layer before it, forming a base for a container's root filesystem. As such, each of the layers may build off of one another to create, by the top layer, the final deliverable. Each layer may represent instructions corresponding to an individually executable sub-application, module, microservice, etc. That is, each layer may be an individually executable unit of instructions that forms a building block of the overall software application. For example, a layer may include an individual microservice. However, each of the layers may be present and/or utilized as a prerequisite to achieving the comprehensive functionality and/or service of the software application container.

The software application container may include a runnable instance of an image. That is, an image may become a container when a command is executed in a file, such as a Docker file, utilized to build the container. Each software application container may be an instance of the image described above.

In some examples, software container images may be stored in a storage and distribution system such as a registry. The registry may be hosted at a host device such as a server. The registry may include a public registry, such as a Docker hub, or a private registry.

The container images at the registry may be managed by a daemon, such as a Docker daemon. The daemon may listen for application programming interface (API) requests and manage responses to the requests.

The software application container images may be shared from the registry. For example, the registry may be a repository of software application container images that may be delivered to a target system where the software container images may be executed.

For example, a container client, such as a Docker client, may be present at and/or executed by an end user's device. The container client at the end user's device and the daemon at the server may communicate with one another to pull a software application container image from the registry to the end user's device. For example, the client on the end user's device may communicate a request across an API to the daemon that the end user wants to utilize a software application.

As described above, the software application container image may be composed of a plurality of layers. For example, the software application container image of the requested software application may include layers A, B, C, D, and E. As such, to execute the software application container image, the end user device will have to have and/or execute layers A, B, C, D, and E as they are all prerequisite layers to the comprehensive functionality of the requested software application.

However, the container client on the end user device may engage in a series of communications with the daemon to communicate that the end user device already possesses layers A and B. As such, the daemon may respond by sending the end user device layers C, D, and E. Therefore, the amount of data sent to the target system is reduced over the entire software application container image (e.g., including layers A, B, C, D, and E), thereby conserving bandwidth and/or computational resources.

However, some target systems may not be able to communicate with the registry. For example, a target system may not have network access to the registry. In such examples, the target systems may not be able to communicate a request for the software application to the daemon and/or may not be able to identify layers of the corresponding software application container image already existing on the target system. That is, since there is no communication between the container client on the target system and the daemon at the registry, there may be no communication regarding which layers exist at the target system. As a result, the entire software application container image (e.g., including layers A, B, C, D, and E) may be exported from the registry and imported local to the target system regardless of the target system already possessing some of the layers. Therefore, excessive bandwidth and/or computational resources may be consumed in exporting/importing duplicative layers and/or container images.

In contrast, examples consistent with the present disclosure may include a mechanism to create an abridged container image deliverable to a target system without communication between the target system and a registry on a host system. That is, in contrast to importing a full copy of all the layers of a container image to a target system, examples consistent with the present disclosure may generate an abridged container image deliverable without communication between the target system and the host. For example, systems consistent with the present disclosure may include a processor and a non-transitory machine-readable storage medium to store instructions. The instructions may be executable by the processor to issue a request from an intermediary system to a daemon service to export a container image, including a plurality of individually executable prerequisite layers, from a host, wherein the plurality of individually executable prerequisite layers includes a first individually executable prerequisite layer absent from a target system and a second individually executable prerequisite layer installed on the target system; and convert the exported container image to an abridged container image, deliverable to the target system, by copying the first individually executable prerequisite layer to an abridged deliverable container without the second individually executable prerequisite layer.

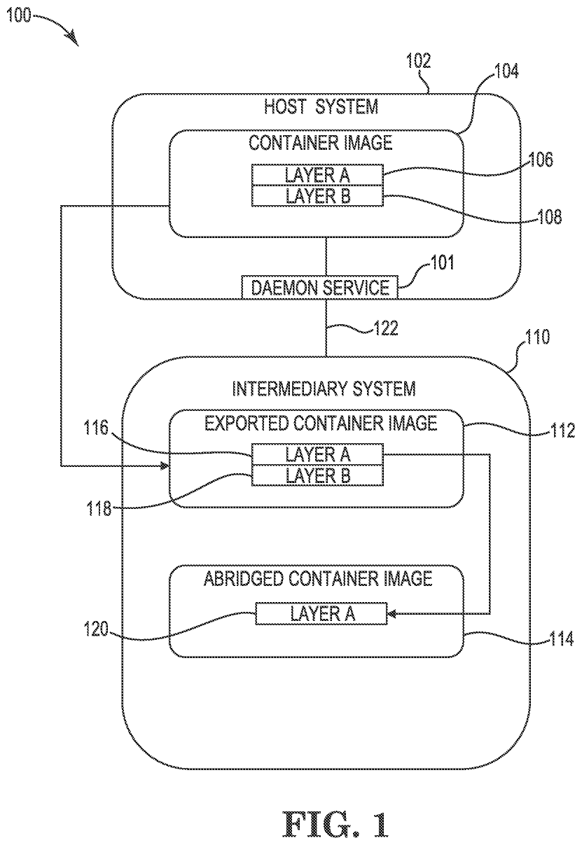

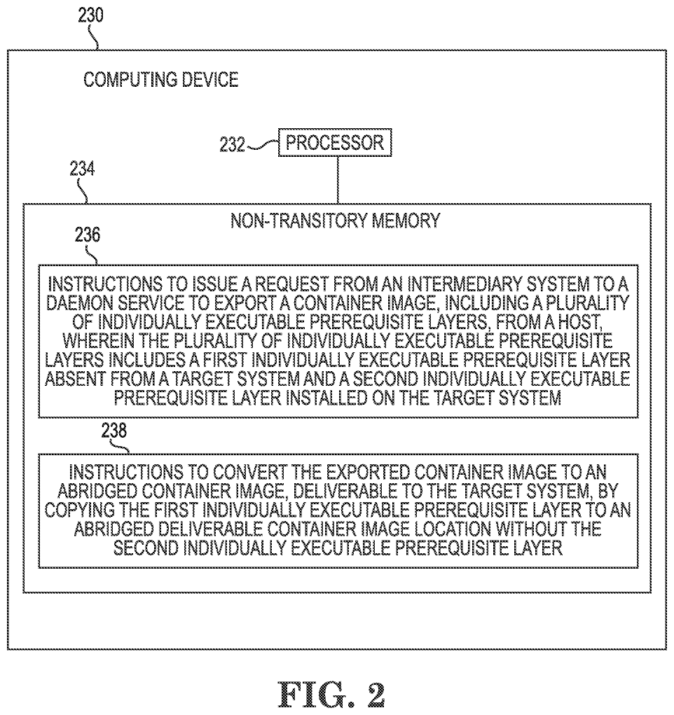

FIG. 1 illustrates an example of a system 100 for generating abridged container images consistent with the present disclosure. The described components and/or operations of the system 100 may include and/or be interchanged with the described components and/or operations described in relation to FIG. 2-FIG. 4.

The system 100 may include a host system 102. A host system 102 may include a computing device and/or instructions executable by a processing resource (e.g., a software application, an operating system, etc.). For example, the host system 102 may include a server, a desktop computer, a laptop computer, etc. The host system 102 may include a computing device which hosts a registry. For example, the host system 102 may, for example, host a storage and distribution system for software application container images. In some examples, the host system 102 may include a Docker registry acting as a storage and distribution system for named Docker images.

The registry may be divided into repositories holding all the versions of a specific container image. The registry may facilitate end users pulling software container images locally to their end user device from the registry. The registry may also facilitate the pushing of new software application container images from end users to the registry. The registry may be public or private. A public registry may include a container registry, such as a Docker Hub, that is a library, repository, and/or community for sharing container images that is open to the public. A private registry may include a container registry that is a library, a repository, and/or a community for container images that enforces restricted access and/or is not open to the public at large.

The host system 102 may be communicatively coupled to a network. For example, the host system 102 may be communicatively coupled to the Internet or some other network (e.g., local area network (LAN), wide area network (WAN), etc.). The host system 102 may be accessed via the network.

The host system 102 may include a daemon service 101. A daemon service 101 may include a set of instructions executable by a processor to manage, export, import, etc. the software application container images stored in the registry. In some examples, the daemon service 101 may include a Docker daemon. As described above, the host system 102 may be communicatively coupled to a network and, as such, may receive API calls over the network. The daemon service 101 may listen for application programming interface (API) requests and manage responses to the requests. For example, the daemon service 101 may monitor traffic coming into the host system 102, identify API requests among the traffic, and respond accordingly.

The system 100 may include an intermediary system 110. The intermediary system 110 may include a set of instructions executable by a processor to perform the functions described herein. The intermediary system 110 may be stored on and/or executed by a separate computing device than the host system 102. However, in some examples, the intermediary system 110 may be stored on and/or executed by the host system 102.

The intermediary system 110 may be communicatively coupled to the host system 102. As such, the intermediary system 110 may be communicatively coupled to the registry and/or the daemon service 101 on the host system 102. For example, the intermediary system 110 may be able to access and/or communicate with the host system 102, the registry, the daemon service 101 etc, via a network or other communication link 122 between the intermediary system 110 and the host system 102. For example, the intermediary system 110 may be able to place API calls to the host system 102, the registry, the daemon service 101 etc. via the network or other communication link 122 therebetween.

The intermediary system 110 may not be a target system. That is, the intermediary system 110 may be stored on and/or executed by a computing device that is not an end user's computing device that is a targeted system where a software application container image will ultimately be imported to, stored, and/or executed by an end user. The intermediary system 110 may not even be communicatively coupled to the target system. That is, the intermediary system 110 may not be stored on, executed by, and/or in communication with a target system where a software container image will ultimately reside as an executable container for use by the end user. For example, the target system may include an end user's computing device that is communicatively isolated. That is, the target system may not be connected to a network or may be part of an air gapped network (e.g., a computer network that is physically isolated from other networks such as unsecured networks, the internet, local area networks, a network to which the intermediary system 110 is communicatively coupled, a network to which the host system 102 is communicatively coupled, etc.). As such, neither the host system 102 nor the intermediary system 110 may be communicatively coupled to the target system.

As such, a target system may not be able to place API calls to the host system 102, the registry, the daemon service 101, etc. Further, the target system may not be able to communicate with either the intermediary system 110 and/or the host system 102, the registry, the daemon service 101, etc. in order to work out which software application containers and/or layers it currently possess and/or those layers that the registry could provide to complete the installation of a new container image at the target system.

As described above, the host system 102 may include a registry for software application container images. As such, the host system 102 may include a container image 104 stored thereupon. The container image 104 may include a Docker container image. The container image 104 may include instructions executable by a processing resource to perform the functionality of a software application. The container image 104 may include instructions, libraries, configuration files, media assets, etc. executable by a target system to perform the functionalities of the software application without utilizing a guest O/S, a hypervisor, etc.

The containerimage 104 may include a plurality of layers (e.g., first layer 106 and second layer 108). The plurality of layers may be cumulatively executable by an end user target system to perform the comprehensive functionality of the container image 104. However, each of the plurality of layers may be individually executable. For example, each of the plurality of layers may include instructions executable as a sub-application or a microservice that acts as a portion of the entire container image 104. Each layer may be individually executable as a unit by the target system separate from the other layers to perform a corresponding functionality that makes up a portion of the comprehensive functionality provided by execution of the entire container image 104. That is, while the cumulative execution of the plurality of layers of the container image 104 may result in the full functionality of the software application that the container image 104 corresponds to, each of the layers may be distinctly executable and/or offer a sub-function.

Each of the plurality of layers may be an individually executable prerequisite layer of the container image 104. That is, in order for the container image 104 to ultimately provide its full comprehensive functionality, the execution and/or presence of each and every layer of the plurality of layers at a target system may be involved. For example, if one of the plurality of layers is missing in a container executing at a target system, the container image 104 may not function, may generate errors, may crash, may lack some functionality, may become unstable, etc. at the target system. As such, the presence of each of the plurality of layers at the target system may be a prerequisite to the intended comprehensive functionality of the container image 104. In some examples, a first layer 106 of the plurality of layers may rely on, refer to, be layered over, and/or utilize a second layer 108 of the plurality of layers when executing. As such, the absence of the second layer 108 may degrade or destroy the ability of the first layer 106 and/or the container image 104 to perform their intended functionality when executed at the target system.

The intermediary system 110 may issue a request to the host system 102. For example, the intermediary system 110 may transmit a request to the host system 102 via a communicative link 122 (e.g., cable, network, radio link, etc.) therebetween. The request may be formatted as an API request. The request may be issued to and/or received by the daemon service 101 managing the registry at the host system 102.

The request may include a request to export a container image 104. The container image 104 may be a specific container image that will be utilized to generate a new deliverable that will ultimately be imported locally to the target system. However, since the target system is not communicatively coupled to either of the intermediary system 110 or the host system 102, the target system may have no role in and/or influence over the export request. That is, as opposed to a target system that may place an API call to the registry and communicate any existing container images or layers at the target system and/or negotiate the export of specific container images or layers from the host system 102, the target system in examples consistent with the present disclosure may not be directly involved with requesting or receiving any container images exported from the host system 102. Instead, the intermediary system 110 may request a container image 104 without input from and/or communication with the target system where the container image will ultimately reside and/or be executed. This may allow the target system to remain communicatively isolated to, for example, maintain control and security over the target system. Additionally, iterative communication between a target system and a host system 102 to negotiate which portions of a container image 104 may be present at or absent from a target system may introduce multiple points of potential failure (e.g., unexpected or aberrant communications, requests, responses, etc.) at each communication. In contrast, removing the communication between the target system and the host system 102 and replacing it with a single request, from an intermediary system 110, to export the container image 104 may eliminate these potential failure point communications.

The container image 104 requested by the intermediary system 110 for export from the host system 102 may include a plurality of layers (e.g., first layer 106 and second layer 108). The request for the container image 104 may include a request for the host system 102 to export the entire container image 104 to the intermediary system 110. That is, the request may include a request to import all the plurality of layers in the container image 104 executable to achieve the comprehensive functionality of the container image 104. The intermediary system 110 may not pick and choose individual layers of the plurality of layers for export but may instead request that the entire container image 104 be exported. The intermediary system 110 may not provide the host system 102 with any data regarding the container images and/or layers stored at and/or executing on the target system. The request may appear to the host system 102 as substantially indistinguishable from an API call from a target system requesting an export of the entire container image 104.

A portion of the plurality of layers of the container image 104 may already exist at and/or be installed on the target device. For example, a first individually executable prerequisite layer 106 may be absent from the target system but a second individually executable prerequisite layer 108 may be installed on the target system. Regardless, the intermediary system 110 may request an export of the entire container image 104 including the first layer 106 and the second layer 108. Again, the target system may not be communicatively coupled to either the intermediary system 110 or the host system 102, foreclosing the communication of which containers or layers are installed on the target system to either the intermediary system 110 or the host system 102.

The intermediary system 110 may receive the exported container image 112 once it is exported from the host system 102. The exported container image may be a Docker container image. The exported container image 112 may be a copy or instance of the container image 104 from the host system 102. The exported container image 112 may be a copy of the entire container image 104 from the host system 102. That is, the exported container image 104 may include each of the plurality of layers that were included in the container image 104 at the host system 102. For example, the exported container image 112 may include a copy of the first individually executable prerequisite layer 116 and a copy of the second individually executable prerequisite layer 118. The exported container image 112 may not be a partial copy of the container image 104 at the host system 102.

The intermediary system 110 may convert the exported container image 112 to an abridged container image 114. The abridged container image 114 may be a docker container image. The abridged container image 114 may include a copy or an instance of the exported container image 112 that is smaller than and/or contains less data that the exported container image 112. For example, the abridged container image 114 may be a copy or an instance of the exported container image 112 that contains less than all of the plurality of layers present in the exported container image 112. The abridged container image 112 may be a new and/or distinct deliverable container as compared to the exported container image 112. That is, the intermediary system 112 may repackage the exported container image 112 into a new and/or modified deliverable. Repackaging the exported container may include copying and containerizing a portion of the exported container image 112 and/or supporting infrastructure as a container stack file such as a Docker stack file.

For example, the intermediary system 110 may convert the exported container image 112 to an abridged container image 114 by selecting layers from the exported container image 112 that should be kept and/or discarded when converting the exported container image 112 to the abridged container image 114. For example, the intermediary system 110 may perform copy/cut and paste style operations on the layers of the exported container image 112 to move or reproduce specific layers from the exported container image 112 to an abridged deliverable container image location (e.g., a storage location located on the intermediary system 110).

The intermediary system 110 may identify and/or select the layers of the exported container image 112 that will be included in and/or excluded from the abridged deliverable container image location. Again, the intermediary system 110 may not be communicatively coupled to an end user's target system. As such, the intermediary system 110 may not communicate with the target system to determine which containers or layers the target system has installed and/or which containers or layers should be included in the abridged container image 114 to generate a fully operable instance of the container image 104 on the target system. Instead, the intermediary system 110 may leverage institutional knowledge and/or historical data regarding the contents of the end user's target system.

For example, the intermediary system 110 may predict which containers and/or layers present in the exported container image 112 are installed at the target system. The predictions may be based on indications of base layer instructions present on the target system as predefined by a distributor, developer, and/or or manufacturer of the hardware, software, firmware, base layers, etc. of the target system.

For example, a manufacturer, developer, and/or distributor of a computing device, its operating system, its preinstalled components, etc. may specify and/or have knowledge of base layers (e.g., container images, container layers, instructions, libraries, operating systems, applications, preinstalled components, etc.) that are installed on the computing device at manufacturing, prior to distribution, upon registering, upon download, etc. As such, based on a base layer of instructions present on the target system, as predefined by a distributor of the base layer of the target system, a prediction may be made regarding which container image and/or container image layers are installed on the target system. That is, the predictions may be based on assumptions of which container image and/or container image layers are installed on the target system based on which container image and/or container image layers are indicated to have been installed on the target system by a manufacturer, distributor, developer, etc, associated with the target system.

These assumptions may not be able to be confirmed with the target system due to the target system not being communicatively coupled to the intermediary system 110. However, the predictions may be relied upon when the manufacturer, distributor, developer, etc. associated with the target system may not support or provide a mechanism for the modification, removal, etc. of these base layer portions from the target system. Further, the manufacturer, distributor, developer, etc. may consider the modification, removal, etc. of the base layers as a breach of protocol or of an agreement that warrants the removal of continuing container image import support for the target system.

As described above, the intermediary system 110 may identify that the first individually executable prerequisite layer 106 is predicted to be absent from the target system. Further, the intermediary system 110 may identify that the second individually executable prerequisite layer 108 is predicted to be installed on the target system. As such, the intermediary system 110 may convert the exported container image 112 to the abridged container image 114 by copying the first individually executable prerequisite layer 116 to an abridged deliverable container image location. The entire first individually executable prerequisite layer 116 may be copied to an abridged deliverable container image location. For example, all of the instructions that make up the first individually executable prerequisite layer 116 may be copied as copy of the entire first individually executable prerequisite layer 116 to the abridged deliverable container image location.

The intermediary system 110 may convert the exported container image 112 to the abridged container image 114 by copying the first individually executable prerequisite layer 116 to an abridged deliverable container image location without the second individually executable prerequisite layer 118. That is, the intermediary system 110 may not copy the second individually executable prerequisite layer 118 from the exported container image 112 to the abridged container image location. The second individually executable prerequisite layer 118 may be left out from and/or not copied to the abridged container image 114.

Therefore, the intermediary system 110 may copy the layers from the exported container image 112 to the abridged container image 114 that are predicted to be absent from the target system and may leave behind the layers that are predicted to be installed at the target system. As such, the abridged container image 114 may be a container deliverable to a target system that includes a copy of the layers of the exported container image 112 that are predicted to not yet be installed at the target system (e.g., first individually executable prerequisite layer 120) and does not include the layers of the exported container image 112 that are predicted to already be installed at the target system.

Therefore, importing the abridged container image 114 locally to the target system would result in just the yet uninstalled layers (e,g., first individually executable prerequisite layer 120) being added to the already installed layers at the target device. The combination of the layer supplied by the abridged container image 114 and the layers already present at the target system may be combined and/or executed to provide the full comprehensive functionality of the container image 104 at the target system. That is, the combination of the layers supplied by the abridged container image 114 and the layers already present at the target system may be combined at the target system to generate a container that is a full comprehensive copy of the container image 104 including all of its plurality of layers.

In some examples, converting the exported container image 112 may include copying configuration data from the exported container image 112 to the abridged container image location. For example, configuration data specifying how and/or where the layer supplied by the abridged container image 114 should be incorporated and/or executed with the layers already present at the target system may be copied from the exported container image 112 to the abridged container image location. The configuration data may be copied from the first individually executable prerequisite layer 116, the second individually executable prerequisite layer 118, and/or a layer other than the first 116 and second 118 individually executable prerequisite layers 116.

The abridged container image 114 may be delivered to a target system. That is, the abridged container image 112 may be imported locally to the target system. The target system is not communicatively coupled to the intermediary system 110 and/or the host system 102 during generating and issuing a request to export a container image 104, receiving the exported container image 112, and converting the exported container image 112 to the abridged container image 114.

Therefore, delivering the abridged container image 114 may involve a manual export of the abridged container image 114 off the intermediary system 110. For example, the abridged container image 114 may be transferred from the intermediary system 110 onto a portable memory device that is communicatively coupled to the intermediary device 110. A portable memory device may include a data storage device that may be connected to a device to access its contents, disconnected to a device to discontinue access to its contents, and moved between devices. For example, a portable memory device may include a thumb drive, a memory card, an external hard drive, etc.

The portable memory device containing the abridged container image 114 may be disconnected from the intermediary system 110 and moved to a target system. Then the portable memory device containing the abridged container image 114 may be connected to the target system and/or its network in a manner that preserves the air gapped nature of the target system and/or preserves the target system's communicative isolation from the intermediary system 110 and/or the host system 102. The abridged container image 114 may be transferred from the portable memory device locally to the target system where its respective layers may be incorporated with existing layers at the target system and be executed to perform the full functionality of the container image 104. For example, the abridged container image 114 may be passed to a container client (e.g., Docker client, etc.) executing on the target system to incorporate the contents of the abridged container image 114 into the target system and/or its existing container images.

In some examples, an intermediary system 110 may be communicatively coupled to the target system after conversion of the exported container image 112 to the abridged container image 114. In some examples, the intermediary system 110 may be communicatively decoupled from the host system 102 (e.g., having the communication link 122 manually unplugged or disconnected, restricting communication between the intermediary system 110 and the host system 102, signing off a unsecured network and signing on to the air gapped network where the target system resides, etc.) prior to being communicatively coupled to the target system. In such examples, the abridged container image 114 may be transferred from the intermediary system 110 to the target system where its respective layers may be incorporated with existing layers at the target system and be executed to perform the full comprehensive functionality of the container image 104. For example, the abridged container image 114 may be passed to a container client (e.g., Docker client, etc.) executing on the target system to incorporate the contents of the abridged container image 114 into the target system and/or its existing container images in a manner that preserves its communicative isolation from the host system 102 and/or a network on which the host system 102 resides.

As such, the system 100 may provide a mechanism for providing container images 104 from a registry to a target system that is communicatively decoupled from a host system 102 where the registry resides. In contrast to a mechanism that delivers the entire container image 104 to the target system, the system 100 may provide the target system with an abridged container image 114 that contains just the portions of the container image 104 that are not already present at the target system. The system creates a new deliverable (e.g., abridged container image 114) that is smaller than the container image 104 on the registry and, as a result, consumes less network and/or computational resources in its importation to the target system. Again, this may be accomplished while the target system is not communicatively coupled to the host system 102 and/or the intermediary system 110.

As such, the target system may be maintained disconnected from a network and/or on an air gapped network throughout without sacrificing the security associated with such isolation and without sacrificing bandwidth and/or computational resources in order to ensure that the entire container image 104 is present at the target system. Further, the system 100 involves no modification to the functionality of the host system 102, the registry on the host system 102, and/or the daemon service 101 managing the registry, which may receive API calls to export the entire container image 104 to the intermediary system 110 without knowledge of the role of the intermediary system 110 and its operations to convert the exported container image 112 to the abridged container image 114.

FIG. 2 illustrates an example of a computing device 230 for generating abridged container images consistent with the present disclosure. The described components and/or operations described with respect to the computing device 230 may include and/or be interchanged with the described components and/or operations described in relation to FIG. 1 and FIG. 3-FIG. 4.

The computing device 230 may include a server, a laptop computer, desktop computer, a tablet computer, smartphone, smart device, Internet of things (IOT) device, etc. The computing device 230 may be an intermediary computing system communicatively coupled to a host system, but not communicatively coupled to a target computing system, where containers from a registry on the host system will ultimately be installed and/or executed. The computing device 230 may include a processor 232 and/or a non-transitory memory 234. The non-transitory memory 234 may include instructions (e.g., 236, 238, etc.) that, when executed by the processor 232, cause the computing device 230 to perform various operations described herein. While the computing device 230 is illustrated as a single component, it is contemplated that the computing device 230 may be distributed among and/or inclusive of a plurality of such components.

The computing device 230 may include instructions 236 executable by the processor 232 to issue a request from an intermediary system to a daemon service. For example, the request may be an API call to a daemon service managing a container registry on a host system. The daemon service may be a Docker daemon service, the registry may be a Docker registry, and the container images stored in the registry may be Docker containers.

The request may include a request to export a container image from the host system. For example, the request may include an API call to export a container image from the registry on the host system to the intermediary system. The container image on the registry may include a plurality of layers and/or other objects and libraries to execute the container image as a containerized application on a target system. That is, the container image may include a plurality of individually executable prerequisite layers. For example, the container image may include a plurality of layers that each contain the instructions for a respective microservice that can be executed independently to perform the microservice but may also be executed as part of a whole including all the plurality of layers to perform the overall service offered by the container image.

The request may include a request to export the entire container image stored in the repository. For example, the request may include an API call requesting the daemon service to export a container image including all of its respective plurality of individually executable prerequisite layers. The request may, therefore, be for a full and complete copy of the entire container image stored in the repository to be executed to the intermediary system.

Relative to a target system where the container image will eventually reside, the container image at the host system may include layers among the plurality of layers which are already installed at the target system at the time of the request. However, the target system may not be the source of the request to the daemon service to export the container image, nor may the target system be communicatively coupled to the host system or the intermediary system.

The request from the intermediary system to the daemon service on the host system may request all of the layers making up a container image regardless of whether they are installed already at the target system. For example, the request may include a request for the host system to export the entire container image, including a first individually executable prerequisite layer that is absent from a target system and a second individually executable prerequisite layer that is installed on the target system, to the intermediary system. In fact, the host system, the registry at the host system, the daemon service managing the registry, etc. may not be notified of a first individually executable prerequisite layer being absent from a target system and a second individually executable prerequisite layer being installed on the target system.

Since the target system may not be communicatively coupled to the host system or the intermediary system, the presence or absence of a container and/or a particular individually executable prerequisite layer of a container image at a target system may not be communicated from and/or confirmed with the target system. Instead, whether a particular individually executable prerequisite layer of a container image is already installed at or is absent from a target system may be based on a prediction. The prediction may be performed by and/or stored at the intermediary system. The prediction may be based on target system manufacturer's, distributor's, developer's, etc. specifications of a base layer that should be present at the target system.

The computing device 230 may include instructions 236 executable by the processor 232 to convert the exported container image to a new deliverable at the intermediary system. For example, the exported container image, including a copy of all the layers of the container image that was exported from the host system may be converted to a new deliverable that is separate from and/or smaller than the exported container image. That is, the exported container image may be converted to an abridged container image that may be a new smaller container relative to the exported container image. The abridged container image may be a deliverable that may be delivered to the target system separate from the exported container image. Although, the target system may not be communicatively coupled to the host system when the request to the daemon service is issued and when the exported container image is converted to the abridged container image. Neither may the intermediary system be communicatively coupled to the target system when the request is issued and when the exported container image is converted to the abridged container image.

The intermediary system may convert the exported container image to an abridged container image by performing copy and paste operations on individual layers of the plurality of layers in the exported container image. For example, the entire first individually executable prerequisite layer described above may be copied to an abridged deliverable container image location at the intermediary system without copying the second individually executable prerequisite layer. The intermediary system may not copy the second individually executable prerequisite layer to the abridged deliverable container image location at the intermediary system, As such, the abridged container image may contain less than all the layers present in the exported container image. For example, the abridged container image may include just the layers that the target system does not yet possess, but which are prerequisites for the comprehensive functionality of the exported container image. The specific layers of the exported image which are selected to be copied to the abridged container image location and/or those that are excluded may be selected based on the above described predictions.

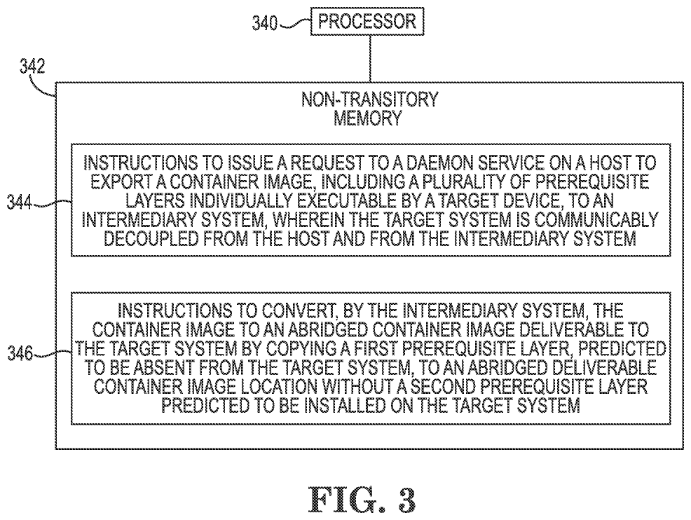

FIG. 3 illustrates an example of a non-transitory machine-readable memory 342 and processor 340 for generating abridged container images consistent with the present disclosure. A memory resource, such as the non-transitory machine-readable memory 342, may be utilized to store instructions (e.g., 344, 346, etc). The instructions may be executed by the processor 340 to perform the operations as described herein. The operations are not limited to a particular example described herein and may include and/or be interchanged with the described components and/or operations described in relation to FIG. 1-FIG. 2 and FIG. 4.

The non-transitory memory 342 may store instructions 344 executable by the processor 340 to issue a request to a daemon service on a host system to export a container image to an intermediary system. The request may be issued by and/or on behalf of an intermediary system that is communicatively coupled to the host system. The intermediary system may not be the end user computing device where the container image may be installed and/or executed. However, the host system may receive the request as an API call that is substantially indistinguishable from an API call places by an end user device.

The container image may include a plurality of prerequisite layers that are individually executable by a target device. The request may include a request for all of the plurality of prerequisite layers of the container image (e.g., the entire container image) to be exported to the intermediary system.

The target system may be communicatively decoupled from the host system and from the intermediary system. For example, the target system may reside on an air gapped network. The air gapped network may communicatively isolate the target system from the intermediary system and/or the host system. As such, the target system may not communicate about and/or be involved in the request and/or the contents of the target system as it relates to the request.

The non-transitory memory 342 may store instructions 344 executable by the processor 340 to convert, by the intermediary system, the exported container image to an abridged container image. The abridged container image may be abridged in that it contains less data than the container image exported to the intermediary system by the host. Specifically, the abridged container image may include a portion of the plurality of layers of the exported container image. The portion may include less than all of the plurality of layers of the exported container image. However, the abridged container image may include entire layers and not portions of individual layers.

The intermediary system may convert the exported container image to the abridged container image that is deliverable to a target system by copying a first prerequisite layer, of the plurality of prerequisite layers making up the exported container image, to an abridged container image location. The first prerequisite layer may be a layer that is predicted to be absent from the target system. The first prerequisite layer may be predicted to be absent from the target system based on a base layer of instructions that are supposed to be present on the target system as predefined by a distributor of the base layer instructions to the target system. The prediction may not be based on communication with the target system, however, because the target system may be communicatively decoupled from the intermediary system and/or the host system.

A second prerequisite layer predicted to be installed on the target system may not be copied to the abridged container image location on the intermediary device. That is, the second layer may be excluded from the abridged container image. As a result, the abridged container image may be smaller than and/or contain less data than the exported container image that was exported to the intermediary system from the host system.

In addition, converting the exported container image to an abridged container image may include copying configuration data from the plurality of prerequisite layers of the exported container image to the abridged container image location. The configuration data may specify instructions on how to insert, structure, operate, and/or execute the first prerequisite layer at the target system. That is, since the abridged container image may include some but not all of the plurality of prerequisite layers of the exported container image, the configuration data may be added to instruct the target device as to how to incorporate and execute the layers included in the abridged container image with the complementary layers already installed at the target system.

After the exported container image is converted to the abridged container image, the abridged container image may be treated as a new deliverable to be delivered to end user target devices. The abridged container image may be imported locally to the end user target devices while preserving their communicative decoupling from the host system and/or the intermediary system. For example, the abridged container image may be manually exported from the intermediary device and manually imported on to the target device in a manner that preserves the air gapping of the target system.

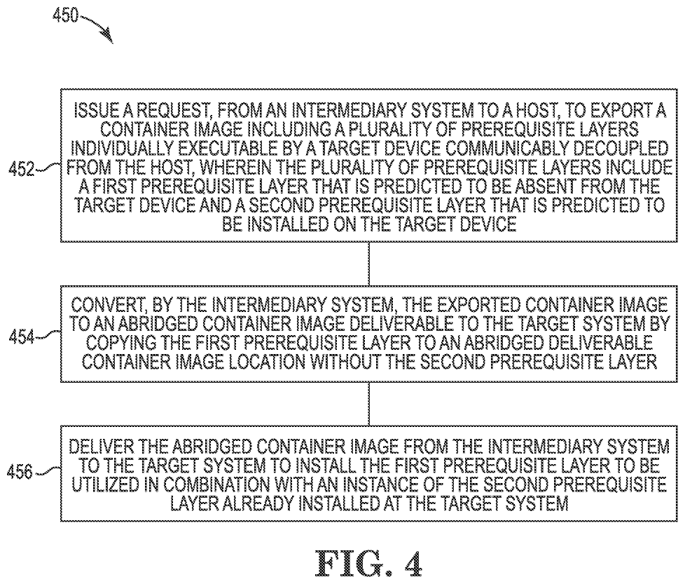

FIG. 4 illustrates an example of a method 450 for generating abridged container images consistent with the present disclosure. The described components and/or operations of method 450 may include and/or be interchanged with the described components and/or operations described in relation to FIG. 1-FIG. 3.

At 452, the method 450 may include issuing a request from an intermediary system to a host. The request may include an API call to a daemon service managing a registry on the host. The request may include a request to export a container image from the host to the intermediary device.

The request may request that the entire container image is to be exported to the intermediary device. For example, the image container may include a plurality of prerequisite layers packaged in the image container. Each of the plurality of prerequisite layers may be individually executable at a target device to perform, for example, a microservice function. The plurality of prerequisite layers may be cumulatively executed at the target device to perform a comprehensive function of the container image. The target system, however, may be communicatively decoupled from the host system and/or the intermediary system. As such, the request may not originate from the target system or communications therewith.

The container image stored in the registry at the host computing system may include, as described above, a plurality of individually executable layers that are prerequisite to the comprehensive function of the container image. Some of the plurality of individually executable layers may already be present at a target system while others may not. For example, the plurality of prerequisite layers may include a first prerequisite layer that is predicted, without communication with the target system, to be absent from the target device and a second prerequisite layer that is predicted, without communication with the target system, to be installed on the target device

At 454, the method 450 may include converting, by the intermediary system, the exported container image to an abridged container image that will be deliverable to a target system. Converting the exported container image to the abridged container image may include identifying, by the intermediary system without a previous version of the exported container image available at the intermediary system, the first prerequisite layer that is predicted to be installed at the target system. The identification of the first prerequisite layer may take place without communication between the intermediary system and the target device.

Converting the exported container image to an abridged container image may include copying the first prerequisite layer to an abridged container image location. The first prerequisite layer may be copied to the abridged container image location without the second prerequisite layer. That is, the finished containerized abridged container image that is packaged as a deliverable for a target system may include the first prerequisite layer but not the second prerequisite layer. The omission of the second prerequisite layer may be based on the prediction that the second prerequisite layer already resides on the target device.

A copy of the exported container image may be retained in its unconverted form. For example, the exported container image may be stored at a memory location off of the target system. In some examples, the intermediary system may retain the exported container image locally in order to use the exported container image for future error analysis and/or to use as a starting point for producing a second abridged container image that contains different layers than the previously described first abridged container image.

At 456, the method 450 may include delivering the abridged container image from the intermediary system to the target system. That is, the abridged container image be delivered locally to the target system as a container image to be incorporated to the target system. The abridged container image may be delivered form the intermediary system to the target system to be installed and/or executed at the target system.

For example, the abridged container image may be delivered from the intermediary system to the target system to install the first prerequisite layer to be utilized (e.g., installed along with, inserted within, executed concurrently with, etc.) in combination with an instance of the second prerequisite layer already installed at the target system. That is, the abridged container image may be delivered from the intermediary system to the target system to provide the remaining uninstalled layers that correspond to the container image requested by the intermediary system.

The delivery of the abridged container image to the target system may be performed in a manner that maintains the communicative isolation of the target system from the host system and/or unsecure networks. This delivery may involve the manual delivery of the abridged container image via a portable memory device which may be coupled to the intermediary system, decoupled form the intermediary system, and then coupled to the target system. Regardless of the delivery mechanism, communication between the host system and the target system may be prevented throughout the delivery. Further, any communication between the intermediary system and the target system may not involve confirmation or exploration of the containers or container layers present on the target system.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processor; and
a non-transitory machine-readable storage medium to store instructions executable by the processor to:
issue a request from an intermediary system to a daemon service to export a container image, including a plurality of individually executable prerequisite layers, from a host system, wherein the plurality of individually executable prerequisite layers includes a first individually executable prerequisite layer absent from a target system and a second individually executable prerequisite layer installed on the target system; and
convert the exported container image to an abridged container image, deliverable to the target system, by copying the first individually executable prerequisite layer to an abridged deliverable container image location without the second individually executable prerequisite layer.

2. The system of claim 1, wherein the target system is not the source of the request to the daemon service to export the container image.

3. The system of claim 1, wherein the daemon service is not notified of the first individually executable prerequisite layer absent from a target system.

4. The system of claim 3, wherein the daemon service is not notified of the a second individually executable prerequisite layer installed on the target system.

5. The system of claim 1, wherein the target system is not communicatively coupled to the host system when the request to the daemon service is issued and when the exported container image is converted to the abridged container image.

6. The system of claim 1, wherein the intermediary system is not communicatively coupled to the target system when the request is issued and when the exported container image is converted.

7. A non-transitory machine-readable storage medium comprising instructions executable by a processor to:
issue a request to a daemon service on a host to export a container image, including a plurality of prerequisite layers individually executable by a target device, to an intermediary system, wherein the target system is communicatively decoupled from the host and from the intermediary system; and
convert, by the intermediary system, an exported container image to an abridged container image deliverable to the target system by copying a first prerequisite layer, predicted to be absent from the target system, to an abridged container image location without a second prerequisite layer predicted to be installed on the target system.

8. The non-transitory machine-readable storage medium of claim 7, wherein the instructions to convert the container image to the abridged container image includes instructions to copy configuration data from the plurality of prerequisite layers to the abridged container image location.

9. The non-transitory machine-readable storage medium of claim 8, wherein the configuration data specifies instructions to execute the first prerequisite layer at the target system.

10. The non-transitory machine-readable storage medium of claim 7, wherein the first prerequisite layer is predicted to be absent from the target system based on a base layer of instructions installed on the target system as predefined by a distributor of the base layer of the target system.

11. The non-transitory machine-readable storage medium of claim 7, wherein the target system resides on an air gapped network.

12. The non-transitory machine-readable storage medium of claim 7, wherein the abridged deliverable container image contains less data than the exported container image exported to the intermediary system by the host.

13. A method comprising:
issuing a request from an intermediary system to a host to export a container image including a plurality of prerequisite layers individually executable by a target device communicatively decoupled from the host, wherein the plurality of prerequisite layers include a first prerequisite layer that is predicted to be absent from the target device and a second prerequisite layer that is predicted to be installed on the target device;
converting, by the intermediary system, the exported container image to an abridged container image deliverable to the target system by copying the first prerequisite layer to an abridged container image location without the second prerequisite layer; and
delivering the abridged container image from the intermediary system to the target system to install the first prerequisite layer to be utilized in combination with an instance of the second prerequisite layer already installed at the target system.

14. The method of claim 13, including retaining the exported container image at a location off the target system.

15. The method of claim 13, including identifying, by the intermediary system without a previous version of the exported container image, the first prerequisite layer to be copied from the exported container image without communication between the intermediary system and the target device.
